(19) United States
(12) Patent Application Publication
(10) Pub. No.: US 2009/0210761 A1
(43) Pub. Date: Aug. 20, 2009

(54) AC Scan Diagnostic Method and Apparatus Utilizing Functional Architecture Verification Patterns

(76) Inventors: Donato O. Forlenza, Hopewell Junction, NY (US); Orazio P. Forlenza, Hopewell Junction, NY (US); Phong T. Tran, Highland, NY (US)

Correspondence Address: IBM CORPORATION;ROCHESTER IP LAW DEPT 917, 3605 HIGHWAY 52 N, ROCHESTER, MN, 55901-7829, US

(21) Appl. No.: 12/031,930

(22) Filed: Feb. 15, 2008

(51) Int. Cl. G06F 11/25; G06F 11/27; G06F 11/263

(52) U.S. Cl. 714/729; 714/733; 714/738; 714/E11.155; 714/E11.169; 714/E11.177

(57) ABSTRACT

A method, apparatus and computer program product are provided for implementing AC scan diagnostic of delay and AC scan chain defects in an integrated circuit chip under test using Functional Architecture Verification Patterns (AVPs) for enabling rapidly localizing identified defects to a failing Shift Register Latch (SRL). An Architecture Verification Pattern (AVP) test pattern set is generated using a chip design input and simulation. AVP test vectors are applied for starting chip clocks and initiating testing, such as Logic Built-In-Self-Test (LBIST).

### FIELD OF THE INVENTION

The present invention relates generally to the data processing field, and more particularly, relates to a method, apparatus and computer program product using Functional Architecture Verification Patterns (AVPs) for implementing AC scan diagnostic of delay and AC scan chain defects to enable rapidly localizing identified defects to a failing Shift Register Latch (SRL).

### DESCRIPTION OF THE RELATED ART

Integrated circuit devices, commonly known as chips, continue to become more powerful and complex as semiconductor manufacturing technologies have advanced. One effect of the increase in the complexity of integrated circuit devices, however, is that testing of the manufactured devices has become significantly more complex and time consuming.

Level Sensitive Scan Design (LSSD) methodology is well known to the prior art. Basically the LSSD methodology is a system design in which the device under test has a plurality of storage elements, latches or registers that are concatenated in one or more scan chains and are externally accessible via one or more serial inputs and outputs. Storage elements that are not so concatenated are usually memory or other special macros that are isolated and can be tested independently. This LSSD methodology ensures that all logic feedback paths are gated by one or more of these concatenated storage elements, thereby simplifying a sequential design into subsets of combinational logic sections.

These basic design concepts, in conjunction with the associated system and scan clocking sequences, greatly simplify the test generation, testing, and the ability of diagnosing very complex logic structures. In such a design every latch can be used as a pseudo Primary Input (PI) and as a pseudo Primary Output (PO), in addition to the standard Primary Inputs and standard Primary Outputs, to enhance the stimulation and observability of the device being tested or diagnosed. Typically LSSD latches are implemented in a configuration having master (L1) and slave (L2) latches where each master latch (L1) has two data ports and may be updated be either a scan clock or a functional clock and each slave latch (L2) has but one clock input that is out of phase with both L1 scan and functional clocks. Scanning is done using separate A and B scan clocks.

The strategy of diagnosing these LSSD circuits has been established and evolving for many years. The primary characteristic of deterministic or pre-determined LSSD patterns is that each pattern is independent from every other pattern and each pattern consists of Primary Inputs, Clocks, a Load, and an Unload sequence. Such LSSD circuits may have thousands of patterns depending upon the size and structure of the logic. During diagnostics, one or more failing patterns are identified and fault simulation is performed on the failing pattern (Load, Primary Inputs, System Clocks, and Unload sequence). The circuit states can be quickly achieved by reviewing and simulating the falling pattern load, any Primary Inputs, System Clocks, and measures. Passing patterns may also be used to eliminate potential faults that the identified failing patterns marked as potential candidates.

However this method of diagnosing of such complex logic structures to determine the devices that have failed functional testing is very time consuming and difficult and is even more difficult when the circuit designs are sequential in nature and utilize a functional pattern test methodology as found in LSSD circuits. General Scan Designs (GSD) circuits are similar and well known to the art.

Additional efforts to enhance device testability incorporate built-in self-test (BIST) circuitry into individual devices to perform predetermined testing operations on the device without the assistance of external circuitry, for example, upon power-up of a device. For example, for logic devices such as processors and controllers, logical built-in self-test (LBIST) circuitry may be used to apply pseudo-random test patterns to logic gates to verify their correct operation.

Similarly, array built-in self-test (ABIST) circuitry may be used to apply test patterns to memory arrays embedded in an integrated circuit device to verify the correct operation of such arrays. ABIST typically applies address, data and control information to an array and clocks the array to first write test patterns to the array. Thereafter, ABIST again applies address, data and control information and clocks the array to read out the stored test patterns to a scan chain or a Multiple-Input Shift Register (MISR). Differences between the written test patterns and the output data indicate potential defects in an array.

A scan test consists of applying a string of alternating logic values (for example, 00 11 00 11 . . . ) to the input of a scan chain, and stepping the data along the scan chain by pulsing the clock inputs thereto. A break in a scan chain, typically as a result of a fault that causes a clock line to remain asserted, is typically indicated if anything other than the original input string is detected at the output of the scan chain.

A major drawback of scan based design test methodology is encountered when the scan chain is not functioning properly and access to the internal logic of the device is greatly reduced, thereby severely complicating the diagnostic process and inhibiting rapid determination of the problem's root cause. In low or zero yield situations, the most common failure is often the scan chain.

Although, the design must be a scan based design, this is very common and the scan chains represent a significant portion of the chip real estate area. Having a solution which speeds AC scan chain diagnostics on the majority of failing chips, eventually results in timely yield improvements thereby ensuring successful production of the design.

These types of problems are usually encountered early in the technology's life cycle and their diagnosis is critical in improving the process, so it quickly achieves manufacturing yield levels. An inability to improve the technology and yield of the device can greatly impact a program or at least severely minimize the revenue that could be realized. Rapid diagnosis to a location for Physical Failure Analysis (PFA) is needed to understand and correct the process anomalies.

U.S. Pat. No. 7,017,095 to Donato Forlenza et al., issued Mar. 21, 2006, and assigned to the present assignee, discloses a method of diagnosing semiconductor device functional testing failures by combining deterministic and functional testing to create a new test pattern based on the functional failure by determining the location of and type of error in the failing circuit. This is accomplished by identifying the failing vector during the functional test, observing the states of the failed device by unloading the values of the latches from the LSSD scan chain before the failing vector, generating a LOAD from the unloaded states of the latches, applying the generated LOAD as the first event of a newly created independent LSSD deterministic pattern, applying the primary inputs and Clocks that produced the failure to a correctly operating device, unloading the output of the correctly operating device to generate a deterministic LSSD pattern; and applying the generated deterministic LSSD pattern to the failing device to diagnose the failure using existing LSSD deterministic tools.

U.S. Pat. No. 7,225,374 to Todd Michael Burdine et al., issued May 29, 2007, and assigned to the present assignee, discloses an apparatus, program product and method that utilize an ABIST circuit provided on an integrated circuit device to assist in the identification and location of defects in a scan chain that is also provided on the integrated circuit device. In particular, a defect in a scan chain may be detected by applying a plurality of pattern sets to a scan chain coupled to an ABIST circuit, collecting scan out data generated as a result of the application of the plurality of pattern sets to the scan chain, and using the collected scan out data to identify a defective latch in the scan chain.

A need exists for an improved mechanism for implementing AC scan diagnostic of delay and AC scan chain defects and rapidly localizing identified defects to a failing Shift Register Latch (SRL).

### SUMMARY OF THE INVENTION

A principal aspect of the present invention is to provide a method, apparatus and computer program product using Functional Architecture Verification Patterns (AVPs) for implementing AC scan diagnostic of delay and AC scan chain defects to enable rapidly localizing identified defects to a failing Shift Register Latch (SRL). Other important aspects of the present invention are to provide such substantially without negative effect and that overcome many of the disadvantages of prior art arrangements.

In brief, a method, apparatus and computer program product using Functional Architecture Verification Patterns (AVPs) are provided for implementing AC scan diagnostic of delay and AC scan chain defects in an integrated circuit device or chip under test. An Architecture Verification Pattern (AVP) test pattern set is generated using a chip design input and simulation. AVP test vectors are applied for starting chip clocks and initiating testing, such as Logic Built-In-Self-Test (LBIST).

In accordance with features of the invention, a generated AVP test pattern is applied to a chip and tested. When the AVP test pattern is verified from being applied to a chip, then the AVP is released for data analysis and characterization to be used for chip testing.

### BRIEF DESCRIPTION OF THE DRAWINGS

The present invention together with the above and other objects and advantages may best be understood from the following detailed description of the preferred embodiments of the invention illustrated in the drawings, wherein:

FIG. 1 is a block diagram representations illustrating an exemplary computer test system using Functional Architecture Verification Patterns (AVPs) for implementing AC scan diagnostic of delay and AC scan chain defects in accordance with the preferred embodiment;

FIGS. 2 and 3 are block diagrams of exemplary scan chain arrangements for use in accordance with the preferred embodiment;

FIGS. 4 and 5 are flow charts illustrating exemplary steps using Functional Architecture Verification Patterns (AVPs) for implementing AC scan diagnostic of delay and AC scan chain defects in accordance with the preferred embodiment;

FIG. 6 is a block diagram illustrating a computer program product in accordance with the preferred embodiment.

### DETAILED DESCRIPTION OF THE PREFERRED EMBODIMENTS

In accordance with features of the invention, a method is provided that utilizes Functional Architecture Verification Patterns (AVPs) for implementing AC scan diagnostic of delay and AC scan chain defects. The method of the invention enables rapidly localizing identified defects to a failing Shift Register Latch (SRL). The invention employs a novel technique and method that efficiently utilizes a self-contained and exhaustive diagnostic test pattern suite of the AVP test patterns that will sensitize and pinpoint the exact AC defective latch within the scan chain of interest.

In accordance with features of the invention, Architectural Verification Patterns (AVPs) and their derivatives are generated to improve test coverage, to exercise slow paths for speed sorting, to exercise the part for power sorting, and to address specific items that need to be screened for at wafer or module test. The AVPs are developed using existing lab and simulation test cases that are then processed thru a specific flow depending on the type of pattern being used. The general, mainline AVPs that are run are LBIST and Trash. For LBIST, a simulation checkpoint of all latches in the chip is taken from a simulation that duplicates what has been verified in the hardware lab. This state is taken and translated into an LSSD load of all the latches. Additional vectors are tacked onto the load in the pattern to start the chip clocks and initiate LBIST. LBIST is then allowed to run for up to 100K loops (˜300 million clocks). At this point the on-chip MISRs are sampled and compared to known signatures. This LBIST pattern causes a significant portion of the chip to toggle. Estimated DC fault coverage (not just toggle coverage) is in the 92% range, therefore giving this technique a high-probability of succeeding.

In accordance with features of the invention, in addition to LBIST, experience has shown that use of functional patterns (i.e. a functional exerciser called Trash) provides with additional coverage of faults in areas that LBIST cannot reach, especially for AC faults. These Trash patterns are comprised of multiple steps to get the chip into the correct setup (GPTR load, Array Initialization, L2 Image Load, Initial State) similar to the LBIST initial load, but with more steps due to the functional nature of the pattern. At this point the pattern executes a set of commands to start the chip clocks and initiate the Trash executable. The pattern is run for a finite time and certain critical error registers and instruction counters are sampled to determine pass/fail condition. The Trash functional exerciser toggles paths (especially areas of logic/array interfaces) that the other pattern types cannot address. It is estimated that these patterns will toggle upwards of 90% of the paths in any given run. The Trash patterns including AVPs then allow SRLs to be switched that are possible very hard to toggle even with so-called random tests like LBIST and some very targeted tests like LSSD, due to functional data and control paths that are being set up and exercised. These patterns then allow this diagnostic technique to have an excellent probability of finding the defective latch.

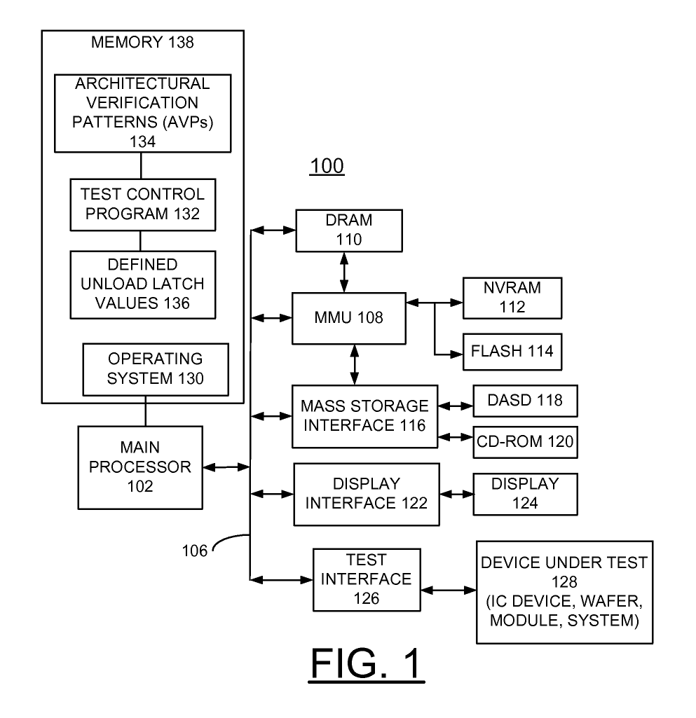

Referring now to the drawings, in FIG. 1 there is shown an exemplary computer test system generally designated by the reference character 100 that utilizes Functional Architecture Verification Patterns (AVPs) for implementing AC scan diagnostic of delay and AC scan chain defects in accordance with the preferred embodiment. Computer system 100 includes a main processor 102 or central processor unit (CPU) 102 coupled by a system bus 106 to a memory management unit (MMU) 108 and system memory including a dynamic random access memory (DRAM) 110, a nonvolatile random access memory (NVRAM) 112, and a flash memory 114. A mass storage interface 116 coupled to the system bus 106 and MMU 108 connects a direct access storage device (DASD) 118 and a CD-ROM drive 120 to the main processor 102. Computer system 100 includes a display interface 122 connected to a display 124, and a test interface 126 coupled to the system bus 106. A device under test 128 is coupled to the test interface 126. The device under test 128 includes, for example, an integrated circuit wafer, a module, or a system. Computer system 100 includes an operating system 130, a test control program 132, and a set of Architecture Verification Patterns (AVPs) 134 of the preferred embodiment, and defined unload latch values 136 resident in a memory 138.

Two modes of collecting “good” unload latch values 136 or the defined unload latch values 136 advantageously are used in this diagnostic process including. In a first approach the latch values 136 are generated prior to test via a good machine simulator (GMS) and stored on the tester or computer system 100. This requires relatively large signature storage capacity on the computer system 100, but needs to be performed only once. When an interactive GMS is readily available during test, the storage problem can be significantly reduced. A second approach, very powerful in some situations, is to use the same device under test 128 to generate the “good” reference latch values. This can be accomplished when the device has an operating range that is functioning properly. This operating range might include a slightly different voltage or timing conditions.

Computer test system 100 is shown in simplified form sufficient for understanding the present invention. The illustrated computer test system 100 is not intended to imply architectural or functional limitations. The present invention can be used with various hardware implementations and systems and various other internal hardware devices, for example, multiple main processors.

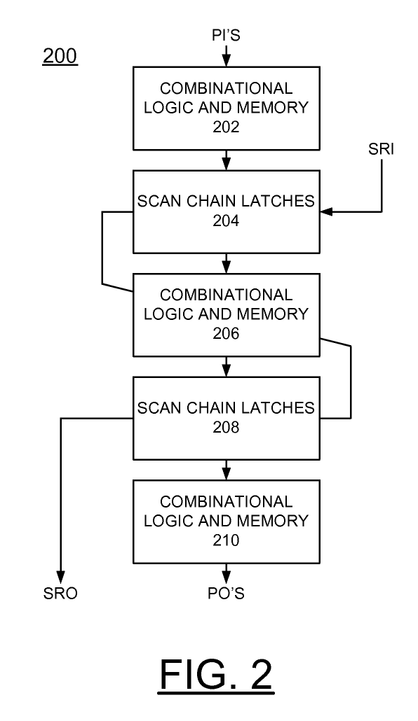

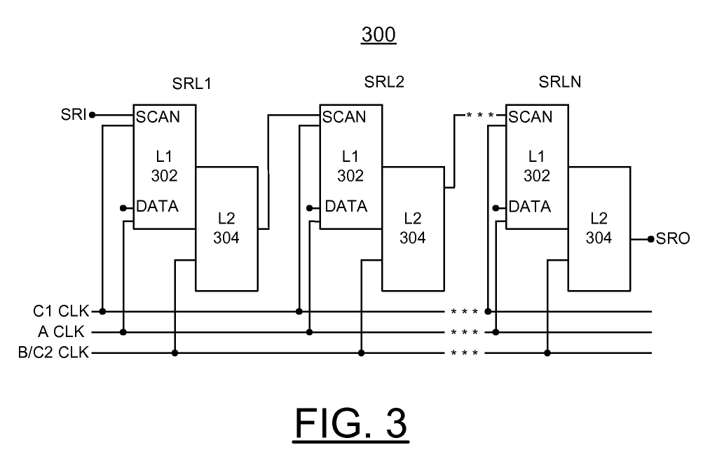

Referring now to FIGS. 2 and 3, there are shown exemplary scan chain arrangements generally designated by the reference characters 200, 300 for use in accordance with the preferred embodiment. The LSSD methodology is a system design and a Design-For-Test (DFT) approach that incorporates several basic test concepts including a scan design.

FIG. 2 illustrates a typical LSSD configuration 200 including a first combinational logic and memory block 202 having applied primary inputs (PIs) and coupled to a first scan chain latches block 204. A second combinational logic and memory block 206 receives primary outputs (POs) from the first scan chain latches block 204 and is coupled to a second scan chain latches block 208. The second scan chain latches block 208 is coupled to a third combinational logic and memory block 210. In the typical LSSD configuration 200 most of the storage elements of the device, such as latches or registers are concatenated in one or more scan chains 204, 208 and can be externally accessible via one or more serial inputs (SRI) and outputs (SRO). Storage elements that are not in this category are usually memory or other special macros that are isolated and tested independently. The LSSD design methodology ensures that all logic feedback paths are gated by one or more of the storage elements, thereby simplifying a sequential design into subsets of combinational logic sections.

FIG. 3 illustrates a typical LSSD scan chain 300 including a chain of Shift Register Latches (SRLs), SRL1-SRLN, each including a master latch L1, 302 and a slave latch L2, 304. The master latch L1, 302 has a pair of data ports SCAN and DATA, that may be captured by the latch responsive either to a first scan clock A CLK or a first functional system clock C1 CLK. The slave latch L2, 304 captures the value stored in the master latch L1, 302 responsive to either a second scan clock B CLK or a second functional system clock C2 CLK. As shown in FIG. 3, the second scan clock B CLK and the second functional system clock C2 CLK are combined as a single clock signal B/C2 CLK. The second scan clock B CLK and the second functional system clock C2 CLK are typically driven out of phase with both the first scan clock A CLK and the first functional system clock C1 CLK applied to the master latch L1, 302.

The strategy of diagnosing LSSD circuits has been established and evolving for many years. The characteristic of deterministic or predetermined LSSD patterns is that each pattern is independent from every other pattern. A pattern consists of a Load, primary inputs (PIs), Clocks, and an Unload sequence. Devices may have thousands of patterns depending upon the size and structure of the logic. During diagnostics, the failing pattern is identified and fault simulation is performed on the failing pattern, Load, PIs, Clocks, and Unload sequence. The circuit states can be quickly achieved by reviewing and simulating the failing pattern load, any PIs/Clocks, and measures. Previous passing patterns may also be used to eliminate potential faults that the identified failing pattern marked as potential candidates.

In accordance with features of the invention, AVP patterns are used and exercised as delay and AC scan chain diagnostic patterns. AVP patterns provide functional system clocks that are applied in a broadside lateral insertion manner, as opposed to sensitization via the scan path, such as to expose the AC defect in what is referred to as the “bad” or failing operating region. At the same time, a “good” or passing operating region under different test conditions is determined. This is normally done via a voltage or frequency timing scheme. At this point, in order to isolate the AC defect, the scan chains are unloaded for each and every LSSD latch for both a passing and a failing operating point. Subsequently, a simple off-line comparison of these unloads for each operating point is performed and hence, the differing latches are noted. These differing latches are then stored and sent to PFA. The above process advantageously is automated and used in a manufacturing environment. Some latches might be expected to differ due to a combination of logic/array, power-up, and unstable latch conditions. These latch types would be characterized and identified prior to the diagnostic process and can be simply cross-referenced against the diagnostic latch calls obtained via this process. These latches are then excluded from the final list of suspected AC defective latch calls for submission to PFA. Therefore, the AC defective SRLs are then identified as the SRLs that differ between the unload data of a “good” and “bad” operating region minus these “unstable” latches.

In summary, by varying the timing and voltage parameters, as well as controlling the total AVP test pattern length and AVP pattern type, such as AVP TRASH, AVP LBIST, AVP GRUB, and the like, the necessary transitions are generated that will allow the AC defect to be sensitized and hence, observed within a latch. These transitions include slow-to-rise (STR) and slow-to-fall (STF) and a more extensive/robust AVP test pattern suite will ensure the AC defect will be identified and pinpointed to a specific latch for successful PFA. This concept can be extended to other AVP test pattern modes, types, and methodologies in the pursuit of causing numerous transitions at the latch boundaries to expose the AC fail. By utilizing these additional AVP test pattern suites as the basis of the AC diagnostic pattern set, which targets different portions of the structure being diagnosed, the probability of causing the required transitions necessary to expose the AC defect is significantly improved and hence, AC diagnostic latch isolation and resolution is thereby improved as well. This AC diagnostic technique can be employed at the wafer, module, and higher-level packages for the device under test 128. However, it is usually more cost effective and advantageous to perform the diagnostics at the wafer level to speed fabrication process and tool corrections, correct design marginality, and improve product wafer yields, especially during early technology introduction.

More or less AVP pattern sets can be applied depending upon the specific design of the device under test 128 being diagnosed. The data results are analyzed to identify the shift register latch (SRL) at which the AVP good unload data differs from the AVP bad unload data. This scan pattern generation and diagnostic process should consider all latch inversions within the scan chains. The AVP methodology tests many different macros on the device 128 and it may be possible to further minimize dependencies on other long chain interactions. Some AVPs 134 may only use a few SR chains to test a specific macro. Before the SRs are unloaded the device 128 may or may not be reconfigured to multiple scan chain mode. This is usually done to minimize the dependency on one single long chain, and for improved diagnostic granularity during the diagnostic process. The variety of the AVP test pattern set 134 enables generating test vectors that will be latched into the system data ports of the SRLs. Executing different AVPs 134 for all the macros can sensitize different functional paths that are observed at SRLs. If a 0 and a 1 is captured in almost every latch for each SR it will be a complete solution and a powerful tool. Executing more AVPs 134 will further enhance, identify, and pinpoint exactly where the AC sensitivity condition begins for the various SR unloads. It is approximated that a significant number of SRLs will switch to a 0 or 1 during the execution of the AVP patterns 134. For example, AVPs 134 usually target approximately 85-90 percent of all the SRLs of the device under test 128 being diagnosed.

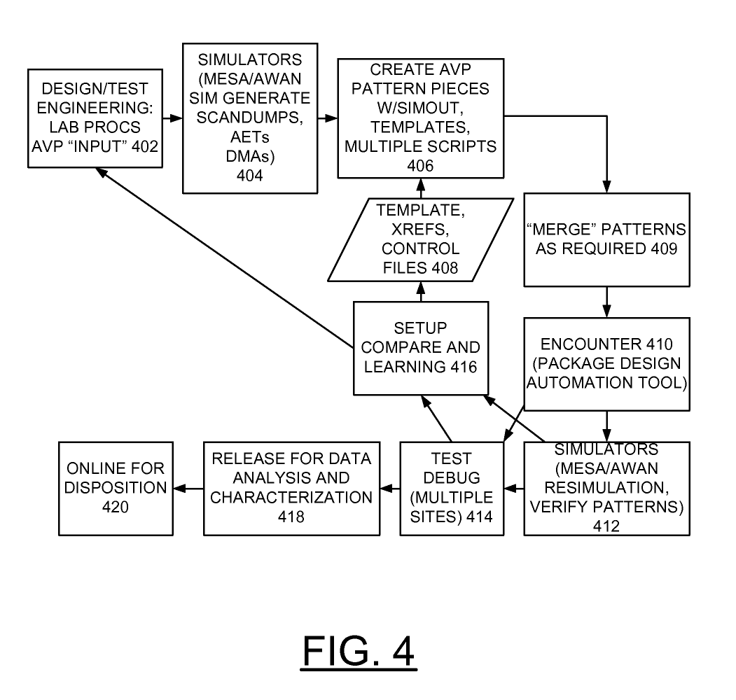

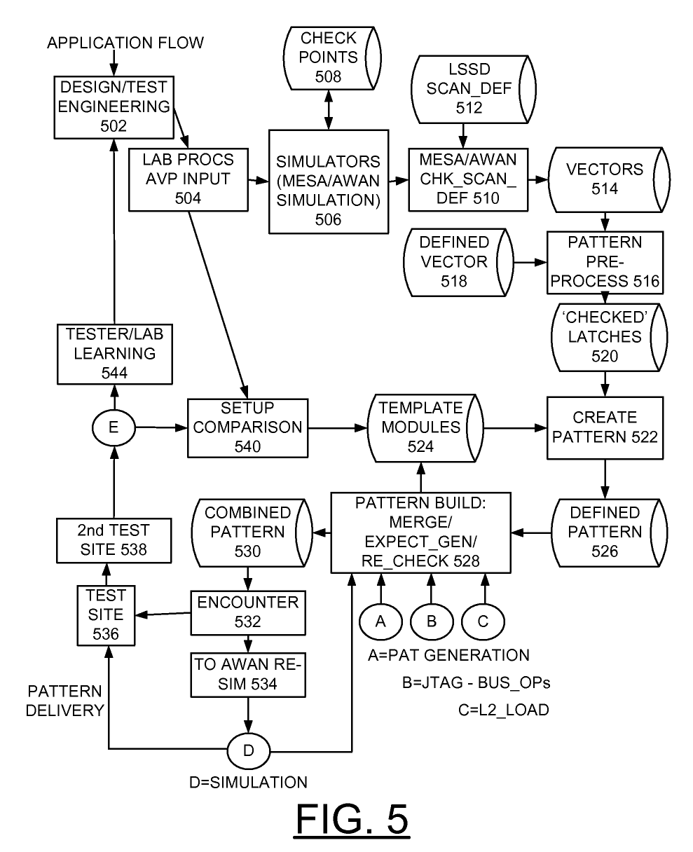

Referring now to FIGS. 4 and 5, there are shown exemplary steps using Functional Architecture Verification Patterns (AVPs) for implementing AC scan diagnostic of delay and AC scan chain defects in accordance with the preferred embodiment.

In FIG. 4, a high level flow chart illustrating the invention starts with design and test engineering providing laboratory procedures of Architecture Verification Pattern input as indicated at a block 402. Simulators, such as Mesa and Awan Simulators, generate scan dump, data structures, such as active edge tables (AETs) and scan dump data DMAs, of an integrated circuit or the device under test 128 including simulation of a scan to the integrated circuit that provides a scan dump as indicated at a block 404. The AVPs are developed using existing lab and simulation test cases at blocks 402 and 404 that are then processed thru a specific flow depending on the type of pattern being used. As indicated at a block 406, AVP pattern pieces are generated using simulation output for AVP pattern set 134 with test vectors applied from templates, cross-references, and control files as indicated at a block 408. The AVP test vectors are applied for starting chip clocks and initiating testing, such as LBIST. The AVP patterns provide AVP functional system clocks applied via a broadside lateral insertion. The AVP patterns are merged as required as indicated at a block 409.

As indicated at a block 410, an encounter step is provided using a package design automation tool or shell that sends the generated AVP pattern set 134. As indicated at a block 412, simulators perform re-simulation to verify the AVP pattern. Otherwise, the AVP patterns are applied to a test debug process as indicated at a block 414, for example, at multiple manufacturing sites where the AVP test patterns are applied to actual chip or device under test 128 with AVP functional system clocks being applied via a broadside lateral insertion. When the AVP test patterns are not verified or did not work, the AVPs are recreated, a setup compare and learning process is performed as indicated at a block 416, and applied to the templates, cross-references, and control files at block 408 and the design and test engineering input at block 402. When the AVP test patterns are verified, the AVPs are releases for data analysis and characterization as indicated at a block 418. Then the AVPs are provided online for disposition as indicated at a block 420.

In FIG. 5, an application flow chart starts with design and test engineering as indicated at a block 502 and providing laboratory procedures for Architecture Verification Pattern input as indicated at a block 504. Simulators, such as Mesa and Awan Simulators, as indicated at a block 506, receive checkpoints as indicated at a block 508. As indicated at a block 510, a simulator check scan definition CHK_SCAN_DEF is generated receiving an LSSD scan definition SCAN_DEF as indicated at a block 512. Vectors are generated as indicated at a block 514, and applied to a pattern pre-processing block as indicated at a block 516, receiving a defined vector input as indicated at a block 518. The additional vectors provided into the AVP 134 being generated are used to start the chip clocks and initiate LBIST. Checked latches are identified as indicated at a block 520. A test pattern, such as a defined AVP is created as indicated at a block 522 receiving template modules as indicated at a block 524. A defined pattern is provided as indicated at a block 526. Next a pattern build process including merge, expect generation, and re-check is performed as indicated at a block 528, receiving inputs indicated at A, B, C, respectively including pattern generation, a test input JTAG less bus operation, and an L2 load, as shown, and applied to the template modules as indicated at a block 524. A combined pattern is generated as indicated at a block 530. An encounter step is provided using a package design automation tool or shell that sends the generated AVP pattern set 134 as indicated at a block 532, and applied to a simulator, such as Awan re-simulator as indicated at a block 534 and a simulation as indicated at D. The pattern delivery is applied to a test site as indicated at a block 536 and a second test site as indicated at a block 538, and forwarded as indicated at E for set up comparison as indicated at a block 540, and tester and lab learning as indicated at a block 544. Then coupled to the design and test engineering at block 502 and providing laboratory procedures of Architecture Verification Pattern input at block 504.

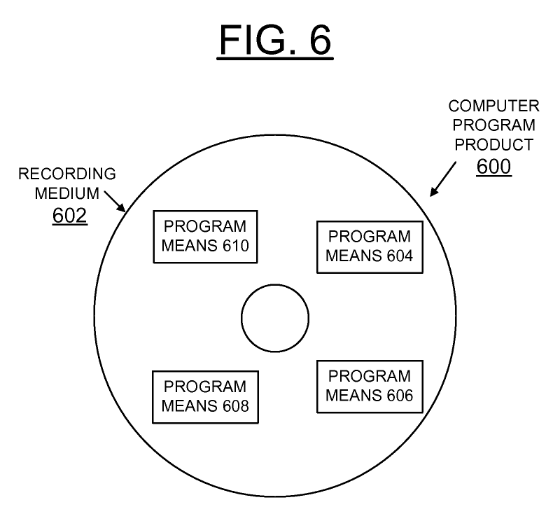

Referring now to FIG. 6, an article of manufacture or a computer program product 600 of the invention is illustrated. The computer program product 600 includes a recording medium 602, such as, a floppy disk, a high capacity read only memory in the form of an optically read compact disk or CD-ROM, a tape, or another similar computer program product. Recording medium 602 stores program means 604, 606, 608, 610 on the medium 602 for carrying out the methods utilizing Functional Architecture Verification Patterns (AVPs) for implementing AC scan diagnostic of delay and AC scan chain defects of the preferred embodiment in the system 100 of FIG. 1.

A sequence of program instructions or a logical assembly of one or more interrelated modules defined by the recorded program means 604, 606, 608, 610, direct the computer system 100 for implementing AC scan diagnostic of delay and AC scan chain defects of the preferred embodiment.

While the present invention has been described with reference to the details of the embodiments of the invention shown in the drawing, these details are not intended to limit the scope of the invention as claimed in the appended claims.

What is claimed is:

1. A method for implementing AC scan diagnostic of delay and AC scan chain defects in an integrated circuit chip under test using Functional Architecture Verification Patterns (AVPs) comprises the steps of:
generating an Architecture Verification Pattern (AVP) test pattern set using a chip design input and simulation; and applying template modules to create the AVP pattern set; the AVP pattern set including AVP test vectors;
said AVP test vectors being applied for starting chip clocks and initiating testing including Logic Built-In-Self-Test (LBIST).

2. The method for implementing AC scan diagnostic of delay and AC scan chain defects as recited in claim 1 wherein the AVP test pattern set includes AVP functional system clocks; and includes applying a generated AVP test pattern to a chip with said AVP functional system clocks applied via a broadside lateral insertion and testing the generated AVP test pattern.

3. The method for implementing AC scan diagnostic of delay and AC scan chain defects as recited in claim 2 includes verifying the generated AVP test pattern and releasing the generated AVP test pattern for data analysis and characterization for chip testing.

4. The method for implementing AC scan diagnostic of delay and AC scan chain defects as recited in claim 1 wherein generating an Architecture Verification Pattern (AVP) test pattern set using a chip design input and simulation includes receiving a simulation input of a Level Sensitive Scan Design (LSSD) scan definition.

5. The method for implementing AC scan diagnostic of delay and AC scan chain defects as recited in claim 1 includes performing a setup comparison of the chip design input and the template modules.

6. The method for implementing AC scan diagnostic of delay and AC scan chain defects as recited in claim 1 includes providing a second simulation for verifying AVP patterns being generated.

7. The method for implementing AC scan diagnostic of delay and AC scan chain defects as recited in claim 1 includes generating and storing unload latch values.

8. The method for implementing AC scan diagnostic of delay and AC scan chain defects as recited in claim 7 includes using the integrated circuit chip under test for generating the unload latch values.

9. Apparatus for implementing AC scan diagnostic of delay and AC scan chain defects in an integrated circuit chip under test using Functional Architecture Verification Patterns (AVPs) comprises:
a computer test system;
a memory storing a set of Architecture Verification Patterns (AVPs);
a test control program for generating an Architecture Verification Pattern (AVP) test pattern set using a chip design input and simulation, and applying template modules to create the AVP pattern set; the AVP pattern set including AVP test vectors; said test control program applying AVP test vectors for starting chip clocks and initiating testing including Logic Built-In-Self-Test (LBIST).

10. Apparatus for implementing AC scan diagnostic of delay and AC scan chain defects as recited in claim 9 wherein the AVP test pattern set includes AVP functional system clocks; and includes said test control program applying a generated AVP test pattern to a chip with said AVP functional system clocks applied via a broadside lateral insertion and testing the generated AVP test pattern.

11. Apparatus for implementing AC scan diagnostic of delay and AC scan chain defects as recited in claim 10 includes said test control program verifying the generated AVP test pattern and releasing the generated AVP test pattern for data analysis and characterization for chip testing.

12. Apparatus for implementing AC scan diagnostic of delay and AC scan chain defects as recited in claim 9 wherein said test control program generating an Architecture Verification Pattern (AVP) test pattern set using a chip design input and simulation includes said test control program receiving simulation input of a Level Sensitive Scan Design (LSSD) scan definition.

13. Apparatus for implementing AC scan diagnostic of delay and AC scan chain defects as recited in claim 9 includes said test control program generating and storing unload latch values.

14. Apparatus for implementing AC scan diagnostic of delay and AC scan chain defects as recited in claim 13 includes said test control program using the integrated circuit chip under test for generating the unload latch values.

15. A computer readable storage medium storing a computer program product for implementing AC scan diagnostic of delay and AC scan chain defects in an integrated circuit chip under test using Functional Architecture Verification Patterns (AVPs) in a computer test system, said computer program product including instructions executed by the computer test system to cause the computer system to perform the steps of:
generating an Architecture Verification Pattern (AVP) test pattern set using a chip design input and simulation; and applying template modules to create the AVP pattern set; the AVP pattern set including AVP test vectors;
said AVP test vectors being applied for starting chip clocks and initiating testing including Logic Built-In-Self-Test (LBIST.

16. A computer readable storage medium storing a computer program product for implementing AC scan diagnostic of delay and AC scan chain defects as recited in claim 15 1 wherein the AVP test pattern set includes AVP functional system clocks; and includes applying a generated AVP test pattern to a chip with said AVP functional system clocks applied via a broadside lateral insertion and testing the generated AVP test pattern.

17. A computer readable storage medium storing a computer program product for implementing AC scan diagnostic of delay and AC scan chain defects as recited in claim 16 includes verifying the generated AVP test pattern and releasing the generated AVP test pattern for data analysis and characterization for chip testing.

18. A computer readable storage medium storing a computer program product for implementing AC scan diagnostic of delay and AC scan chain defects as recited in claim 15 wherein generating an Architecture Verification Pattern (AVP) test pattern set using a chip design input and simulation includes receiving a simulation input of a Level Sensitive Scan Design (LSSD) scan definition.

19. A computer readable storage medium storing a computer program product for implementing AC scan diagnostic of delay and AC scan chain defects as recited in claim 15 includes the steps of generating and storing unload latch values.

20. A computer readable storage medium storing a computer program product for implementing AC scan diagnostic of delay and AC scan chain defects as recited in claim 19 includes using the integrated circuit chip under test for generating the unload latch values.
